(19) United States
(12) Patent Application Publication
(10) Pub. No.: US 2023/0089248 A1
(43) Pub. Date: Mar. 23, 2023

(54) NEGATIVE ELECTRODE AND RECHARGEABLE LITHIUM BATTERY INCLUDING THE SAME

(71) Applicant: SAMSUNG SDI CO., LTD., Yongin-si (KR)

(72) Inventors: Min-young JEONG, Yongin-si (KR); Juhye BAE, Yongin-si (KR); Won-Gi AHN, Yongin-si (KR); Taeil LEE, Yongin-si (KR)

(21) Appl. No.: 17/873,047

(22) Filed: Jul. 25, 2022

(30) Foreign Application Priority Data
Jul. 27, 2021 (KR) 10-2021-0098788

(51) Int. Cl. H01M 4/36; H01M 4/133; H01M 4/134; H01M 4/38; H01M 4/587; H01M 10/052

(52) U.S. Cl. CPC H01M 4/366; H01M 4/133; H01M 4/134; H01M 4/386; H01M 4/587; H01M 10/052; H01M 2004/021

(57) ABSTRACT

A negative electrode active material for a rechargeable lithium battery and a rechargeable lithium battery including the same are provided. The negative electrode includes a current collector and a negative electrode active material layer on the current collector. The negative electrode active material layer includes a first region in contact with the current collector and including a first negative electrode active material, and a second region on the first region and including a second negative electrode active material. Each of the first and second negative electrode active materials has an average particle diameter (D50) of about 9 μm to about 22 μm, morphologies that are different from each other, a porosity of the second region is higher than that of the first region, and a porosity ratio of the second region to the first region is from about 110% to about 190%.

### CROSS-REFERENCE TO RELATED APPLICATION

This application claims priority to and the benefit of Korean Patent Application No. 10-2021-0098788, filed in the Korean Intellectual Property Office on Jul. 27, 2021, the entire content of which is hereby incorporated by reference.

### BACKGROUND

### 1. Field

Aspects of one or more embodiments of the present disclosure relate to a negative electrode for a rechargeable lithium battery and a rechargeable lithium battery including the same.

### 2. Description of the Related Art

A portable information device such as a cell phone, a laptop, smart phone, and/or the like or an electric vehicle has utilized a rechargeable lithium battery relatively having a high energy density and an easy portability as a driving power source. Recently, research has also been actively conducted to utilize a rechargeable lithium battery with a relatively high energy density as a driving power source or power storage power source for hybrid or electric vehicles.

The rechargeable lithium battery should have a relatively high-capacity electrode, but because there is a limit to increasing capacity of an active material itself, it may be necessary to increase an amount of the active material and thus make the electrode thicker. As an electrode plate becomes thicker, resistance of lithium ions within pores of the electrode plate becomes more important to performance of the electrode than resistance of insertion of the lithium ions into the active material. However, because this internal resistance may vary greatly depending on a structure of the electrode plate, one or more suitable studies are being conducted in order to reduce the resistance by improving the structure of the electrode plate.

### SUMMARY

An aspect of one or more embodiments of the present disclosure is directed toward a negative electrode for a rechargeable lithium battery that, in a thick-film electrode that increases or maximizes capacity, and is capable of alleviating non-uniformity of resistance, improving output characteristics, improving capacity retention at high rates, and maintaining high cycle-life even during rapid charging and discharging, and a rechargeable lithium battery including the same.

Additional aspects will be set forth in part in the description which follows and, in part, will be apparent from the description, or may be learned by practice of the presented embodiments of the disclosure.

An embodiment provides a negative electrode for a rechargeable lithium battery including a current collector and a negative electrode active material layer disposed on the current collector, wherein the negative electrode active material layer includes a first region in contact with the current collector and including a first negative electrode active material, and a second region disposed on the first region and including a second negative electrode active material, each of the first negative electrode active material and second negative electrode active material has an average particle diameter (D50) of about 9 μm to about 22 μm, morphologies of the first negative electrode active material and the second negative electrode active material are different from each other, a porosity of the second region is higher than that of the first region, and a ratio of the porosity of the second region to the porosity of the first region ranges from about 110% to about 190%.

Another embodiment provides a rechargeable lithium battery including the negative electrode, a positive electrode, and an electrolyte.

The negative electrode manufactured according to an embodiment and the rechargeable lithium battery including the same, alleviates (reduces) the resistance non-uniformity in the thick-film electrode (the negative electrode), improves output characteristics and capacity retention rate at a high rate, and a high cycle-life even during rapid charging and discharging while realizing high capacity.

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure and, together with the description, serve to explain principles of the present disclosure. In the drawings:

FIG. 1 is a cross-sectional view illustrating a rechargeable lithium battery according to an embodiment.

FIG. 2 is a scanning electron microscopic image of the first negative electrode active material according to Example 1.

FIG. 3 is a scanning electron microscopic image of the second negative electrode active material according to Example 1.

FIG. 4 is a scanning electron microscopic image of a cross-section of the negative electrode according to Example 1.

FIG. 5 is a graph showing porosities of the negative electrode active material layers of Example 1, Comparative Example 1, and Comparative Example 2 measured through nano-computed tomography.

FIG. 6 is a graph showing discharge rates according to C-rates for the battery cells of Example 1, Comparative Example 1, and Comparative Example 2.

FIG. 7 is a graph showing a lithium precipitation amount according to C-rates for the battery cell of Comparative Example 1.

FIG. 8 is a graph showing a lithium precipitation amount according to C-rates for the battery cell of Example 1.

FIG. 9 is a scanning electron microscopic image of a cross-section of the negative electrode according to Example 2.

FIG. 10 is a scanning electron microscopic image of a cross-section of the negative electrode according to Example 3.

FIG. 11 is a scanning electron microscopic image of a cross section of the negative electrode according to Comparative Example 3.

### DETAILED DESCRIPTION

Hereinafter, specific embodiments will be described in more detail so that those of ordinary skill in the art can implement them. However, this disclosure may be embodied in many different forms and is not construed as limited to the example embodiments set forth herein.

The terminology utilized herein is utilized to describe embodiments only, and is not intended to limit the present disclosure. The singular expression includes the plural expression unless the context clearly dictates otherwise.

As utilized herein, “a combination thereof” refers to a mixture, a laminate, a composite, a copolymer, an alloy, a blend, a reaction product, constituents, and/or the like.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or one or more combinations thereof.

In the drawings, the thickness of layers, films, panels, regions, etc., may be exaggerated for clarity and like reference numerals designate like elements throughout the disclosure, and duplicative descriptions thereof may not be provided. It will be understood that when an element such as a layer, film, region, or substrate is referred to as being “on” another element, it can be directly on the other element or intervening element(s) may also be present. In contrast, when an element is referred to as being “directly on” another element, there are no intervening elements (not any intervening element) present.

In some embodiments, “layer” herein includes not only a shape formed on the whole surface when viewed from a plan view, but also a shape formed on a partial surface.

In some embodiments, the average particle diameter may be a particle size measured by a method generally utilized/generally available to those skilled in the art, for example, may be measured by a particle size analyzer, or may be measured by a transmission electron micrograph or a scanning electron micrograph. In some embodiments, it is possible to obtain an average particle diameter value by measuring utilizing a dynamic light scattering method, performing data analysis, counting the number of particles for each particle size range, and calculating from this. Unless otherwise defined, the average particle diameter is measured by a particle size analyzer, and may refer to the diameter or size (D50) of particles having a cumulative volume of 50 volume % in the particle size distribution.

### Negative Electrode

In an embodiment, a negative electrode for a rechargeable lithium battery includes a current collector and a negative electrode active material layer disposed on the current collector, wherein the negative electrode active material layer includes a first region in contact with the current collector and including a first negative electrode active material, and a second region disposed on the first region and including a second negative electrode active material. Herein, an average particle diameter (D50) of each of the first negative electrode active material (in particle form) and the second negative electrode active material is about 9 μm to about 22 μm, and morphologies of the first negative electrode active material and the second negative electrode active material are different from each other. In some embodiments, a porosity of the second region is higher than that of the first region, and a ratio of the porosity of the second region to the porosity of the first region is about 110% to about 190%.

The negative electrode for the rechargeable lithium battery may be a thick-film (filmed) electrode plate for maximizing or increasing capacity. As the electrode plate becomes thicker, insertion of lithium ions are more difficult into the current collector of the electrode plate during the charge, and accordingly, resistance is concentrated on the surface of the electrode plate, resulting in resistance non-uniformity, which is further exacerbated in high-rate batteries. An embodiment may provide a negative electrode for a rechargeable lithium battery structurally having the second region with higher porosity than that of the first region by applying a negative electrode active material having different morphologies in the first region (lower or inner portion) and the second region (upper or outer portion) as well as making the electrode plate thicker to increase capacity. Thereby, the resistance on the surface of the electrode plate may be alleviated (reduced) and the output characteristics of the battery may be improved.

In an embodiment, the ratio of the porosity of the second region to the porosity of the first region may range from about 110% to about 190%, for example, about 120% to about 190%. A negative electrode for a rechargeable lithium battery that satisfies these ranges may alleviate non-uniformity phenomenon of resistance and may exhibit excellent or suitable output characteristics while implementing a high capacity. The porosity may be measured through nano-computed tomography (nano-CT), a scanning electron microscope (SEM), or other general methods. A ratio of the porosity of the second region to the porosity of the first region is calculated according to a calculation equation {(porosity of second region)/(porosity of first region)×100%}.

The porosity of the first region, which is measured through the nano-computed tomography, may be greater than or equal to about 5% and less than about 16%, for example, about 5% to about 15.5%, about 7% to about 15.5%, about 9% to about 15.5%, about 10% to about 15.5%, or about 12% to about 15%. In some embodiments, the porosity of the second region, which is measured through the nano-computed tomography, may be greater than or equal to about 16% and less than about 25%, for example, about 16% to about 24%, about 16% to about 22%, about 16% to about 20%, or about 17% to about 19%. When the first region and the second region satisfy these porosity ranges, the resistance non-uniformity of the electrode plate may be alleviated, and output characteristics and cycle-life characteristics may be improved. However, the porosity may vary depending on the type or kind of the negative electrode active material and the composition of the negative electrode active material layer slurry.

The porosity of the first region, which is measured through an image of the scanning electron microscope, may be greater than or equal to about 5% and less than about 13%, for example, about 5% to about 12.5%, about 7% to about 12.5%, about 9% to about 12.5%, or about 10% to about 12%, and the porosity of the second region may be greater than or equal to about 13% and less than about 25%, for example, about 13% to about 24%, about 13% to about 22%, about 14% to about 20%, or about 15% to about 19%. When the first region and the second region satisfy the porosity ranges, the resistance non-uniformity of the electrode plate may be alleviated, and output characteristics and cycle-life characteristics may be improved. However, the porosity may vary depending on the type or kind of the negative electrode active material and the composition of the negative electrode active material layer slurry.

The first negative electrode active material applied to the first region and the second negative electrode active material applied to the second region may have the same average particle diameters and different morphologies. For example, the first negative electrode active material may be substantially spherical, and the second negative electrode active material may be amorphous. In an embodiment, the spherical shape includes a shape similar to a sphere and refers to a round shape without an angle. The first negative electrode active material has a morphology close to (similar to) a sphere and has a form easily pressed during the compression. The first region composed of these has a high internal density and relatively low porosity. The second negative electrode active material has a substantially non-uniform morphology, whose specific surface area is higher than that of a spherical shape. The second region composed of these may have a relatively (compared to the first negative electrode) high porosity.

The first negative electrode active material and the second negative electrode active material may each include a carbon-based active material. The carbon-based active material may include crystalline carbon, amorphous carbon, or a combination thereof. Examples of the crystalline carbon may include sheet-shaped, flake-shaped, sphere-shaped, and/or fiber-shaped graphite and the graphite may be natural graphite and/or artificial graphite. The amorphous carbon may be a soft carbon, a hard carbon, a mesophase pitch carbonization product, calcined coke, and/or the like.

The average particle diameter (D50) of the first negative electrode active material and the average particle diameter (D50) of the second negative electrode active material may be similar to each other, and may range from about 9 μm to about 22 μm. The average particle diameter of the first negative electrode active material and the average particle diameter of the second negative electrode active material may range, for example, from about 10 μm to about 21 μm, from about 10 μm to about 20 μm, from about 11 μm to about 19 μm, or from about 12 μm to about 18 μm, respectively. When the first negative electrode active material and the second negative electrode active material satisfy these particle diameter ranges, high capacity may be realized and excellent or suitable output characteristics and cycle-life characteristics may be exhibited.

A tap density of the first negative electrode active material may be greater than a tap density of the second negative electrode active material. For example, the tap density of the first negative electrode active material may range from about 1.2 g/cc to about 1.5 g/cc, and the tap density of the second negative electrode active material may range from about 0.8 g/cc to about 1.4 g/cc. In some embodiments, the first negative electrode active material may have a tap density of about 1.25 g/cc to about 1.5 g/cc, and the second negative electrode active material may have a tap density of about 1.0 g/cc to about 1.24 g/cc. When the tap densities of the first negative electrode active material and the second negative electrode active material each satisfy these ranges, the porosity of the second region may be designed to be higher than that of the first region, thereby alleviating non-uniformity of resistance and improving output characteristics and cycle-life characteristics of the battery. The tap density may be measured by filling a 100 cc measuring cylinder with 50 cc of a negative electrode active material, performing tapping 1000 times to reciprocate a height of 3 mm every second, and then dividing the mass by volume.

A BET (Brunauer, Emmett and Teller) specific surface area of the first negative electrode active material may be greater than that of the second electrode negative electrode active material. For example, the BET specific surface area of the first negative electrode active material may range from about 1.4 m²/g to about 2.0 m²/g, and the specific surface area of the second negative electrode active material may range from about 1.0 m²/g to about 1.8 m²/g. In some embodiments, the BET specific surface area of the first negative electrode active material may range about 1.5 m²/g to about 2.0 m²/g, and the specific surface area of the second negative electrode active material may range about 1.0 m²/g to about 1.7 m²/g. When the first negative electrode active material and the second negative electrode active material have each BET specific surface area satisfying these ranges, the second region may be designed to have higher porosity than the first region, thereby alleviating the resistance non-uniformity and improving output characteristics and cycle-life characteristics of a battery.

In some embodiments, the first region and/or the second region may further include a silicon-based active material. When the silicon-based active material is further included, a rechargeable lithium battery having a higher capacity may be realized. The silicon-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and/or one or more combinations thereof, but not Si (i.e., Si may not be Q in the Si-Q alloy).

The silicon-carbon composite may be, for example, a silicon-carbon composite including a core including crystalline carbon and silicon particles and an amorphous carbon coating layer disposed on the surface of the core. The crystalline carbon may be artificial graphite, natural graphite, or a combination thereof. The amorphous carbon precursor may be a coal-based pitch, mesophase pitch, petroleum-based pitch, coal-based oil, petroleum-based heavy oil, or a polymer resin such as a phenol resin, a furan resin, or a polyimide resin. In this embodiment, the content (e.g., amount) of silicon may be about 10 wt % to about 50 wt % based on the total weight of the silicon-carbon composite. In some embodiments, the content (e.g., amount) of the crystalline carbon may be about 10 wt % to about 70 wt % based on the total weight of the silicon-carbon composite, and the content (e.g., amount) of the amorphous carbon may be about 20 wt % to about 40 wt % based on the total weight of the silicon-carbon composite. In some embodiments, a thickness of the amorphous carbon coating layer may be about 5 nm to about 100 nm. An average particle diameter (D50) of the silicon particles may be about 10 nm to about 200 nm. The silicon particles may exist in an oxidized form, and in this case, an atomic content (e.g., amount) ratio of Si:O in the silicon particles indicating a degree of oxidation may be about 99:1 to about 33:66. The silicon particles may be SiOₓ particles, and in this embodiment, the range of x in SiOₓ may be greater than about 0 and less than about 2.

The average particle diameter (D50) of the silicon-based active material may range from about 1 μm to about 20 μm, or for example, from about 5 μm to about 15 μm. The silicon-based active material may have a tap density of about 0.3 g/cc to about 1.1 g/cc, for example, about 0.5 g/cc to about 1.0 g/cc. In some embodiments, the silicon-based active material may have a BET specific surface area of about 1.9 m²/g to about 2.7 m²/g, for example, about 2.0 m²/g to about 2.5 m²/g. The silicon-based active material may be one or more suitable morphologies such as a substantially spherical shape, an irregular shape, and/or the like, for example, a shape close to (similar to) the spherical shape. When properties of the silicon-based active material satisfy the ranges, a negative electrode including the same may improve cycle-life characteristics and general battery performance such as charge and discharge efficiency and/or the like.

When the first region and/or the second region further include the silicon-based active material, the silicon-based active material may be included in an amount of about 1 wt % to about 15 wt %, or for example, about 5 wt % to about 14 wt % based on the total weight of each region. When the silicon-based active material is included in this amount range, the rechargeable lithium battery may exhibit excellent or suitable output characteristics and cycle-life characteristics while realizing a high capacity.

The negative electrode for a rechargeable lithium battery according to an embodiment may be a thickened negative electrode for maximizing or increasing capacity, and thus each thickness of the first region and each thickness of the second region may range from about 30 μm to about 100 μm, for example, about 30 μm to about 80 μm, or about 40 μm to about 70 μm. A total thickness of the negative electrode active material layer including the first region and the second region may range from about 60 μm to about 200 μm, for example, about 70 μm to about 150 μm, or about 80 μm to about 140 μm. When the negative electrode active material layer is formed on both (e.g., simultaneously) surfaces of the current collector, the negative electrode may have a total thickness of about 120 μm to about 400 μm, about 130 μm to about 400 μm, for example, about 150 μm to about 300 μm, or about 160 μm to about 250 μm. When each region and the thickness of the negative electrode satisfy the ranges, very high capacity may be realized, and according to an embodiment, porosities of the first region and the second region may be adjusted to realize excellent or suitable output characteristics and cycle-life characteristics with this thickness. In contrast, a thickness of each region may be a thickness of the compressed electrode plate.

In the negative electrode active material layer, the content (e.g., amount) of the negative electrode active material may be about 90 wt % to about 99.9 wt %, or about 95 wt % to about 99 wt % based on the total weight of the negative electrode active material layer.

In an embodiment, the negative electrode active material layer may further include a binder, and may optionally further include a conductive material. The content (e.g., amount) of the binder in the negative electrode active material layer may be about 0.5 wt % to about 5 wt %, or about 1 wt % to about 3 wt % based on the total weight of the negative electrode active material layer. In some embodiments, when the conductive material is further included, the negative electrode active material layer may include about 90 wt % to about 98 wt % of the negative electrode active material, about 1 wt % to about 5 wt % of the binder, and about 1 wt % to about 5 wt % of the conductive material.

Both the first region and the second region in the negative electrode active material layer may include a binder, wherein the binder may be included in an amount of about 0.5 wt % to about 5 wt % based on the total weight of each region. In some embodiments, the binder of the first region and the binder of the second region may be utilized in a weight ratio of about 60:40 to about 95:5, for example, about 70:30 to about 90:10. When the weight ratio of the binders of the first region and the second region satisfies these ranges, a stable electrode plate, although thickened, may be obtained, and output characteristics and cycle-life characteristics of a battery and/or the like may be improved.

The binder serves to well adhere (strongly adhere) the negative electrode active material particles to each other and also to adhere the negative electrode active material to the current collector. The binder may be a water-insoluble binder, a water-soluble binder, or a combination thereof.

Examples of the water-insoluble binder include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or one or more combinations thereof.

The water-soluble binder may include a rubber binder or a polymer resin binder. The rubber binder may be selected from among a styrene-butadiene rubber, an acrylated styrene-butadiene rubber, an acrylonitrile-butadiene rubber, an acrylic rubber, a butyl rubber, a fluororubber, and one or more combinations thereof. The polymer resin binder may be selected from among polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and one or more combinations thereof.

When a water-soluble binder is utilized as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and utilized. As the alkali metal, Na, K, or Li may be utilized. The amount of the thickener utilized may be about 0.1 parts by weight to about 3 parts by weight based on 100 parts by weight of the negative electrode active material.

The conductive material is included to provide electrode conductivity. Any suitable electrically conductive material may be utilized as a conductive material unless it causes a chemical change. Examples of the conductive material include a carbon-based material such as natural graphite, artificial graphite, carbon black, acetylene black, ketjen black, a carbon fiber, a carbon nanofiber, a carbon nanotube, and/or the like; a metal-based material of a metal powder or a metal fiber including copper, nickel, aluminum, silver, and/or the like; a conductive polymer such as a polyphenylene derivative; or one or more mixtures thereof.

The current collector may include one selected from among a copper foil, a nickel foil, a stainless steel foil, a titanium foil, a nickel foam, a copper foam, a polymer substrate coated with a conductive metal, and one or more combinations thereof.

In contrast, in the negative electrode according to an embodiment, the second region may be formed after forming the first region in the current collector, or the first and second regions may be concurrently (e.g., simultaneously) formed by utilizing an application equipment such as a double slot die and/or the like and then, drying and compressing it (the resulting material).

### Positive Electrode

A positive electrode for a rechargeable lithium battery may include a current collector and a positive electrode active material layer disposed on the current collector. The positive electrode active material layer may include a positive electrode active material, and may further include a binder and/or a conductive material.

The positive electrode active material may include lithiated intercalation compounds that reversibly intercalate and deintercalate lithium ions. Examples of the positive electrode active material include a compound represented by one or more of the following chemical formulas:

LiₐA_{1-b}X_{b}D₂(0.90≤a≤1.8,0≤b≤0.5);

LiₐA_{1-b}X_{b}O_{2-c}D_{c}(0.90≤a≤1.8,0≤b≤0.5,0≤c≤0.05);

LiₐE_{1-b}X_{b}O_{2-c}Dc(0.90≤a≤1.8,0≤b≤0.5,0≤c≤0.05);

LiₐE_{2-b}X_{b}O_{4-c}D_{c}(0.90≤a≤1.8,0≤b≤0.5,0≤c≤0.05);

LiₐNi_{1-b-c}Co_{b}X_{c}D_{α}(0.90≤a≤1.8,0≤b≤0.5,0≤c≤0.5,0<α≤2);

LiₐNi_{1-b-c}Co_{b}X_{c}O_{2-α}T_{α}(0.90≤a≤1.8,0≤b≤0.5,0≤c≤0.05,0<α<2);

LiₐNi_{1-b-c}Co_{b}X_{c}O_{2-α}T₂(0.90≤a≤1.8,0≤b≤0.5,0≤c≤0.05,0<α<2);

LiₐNi_{1-b-c}Mn_{b}X_{c}D_{α}(0.90≤a≤1.8,0≤b≤0.5,0≤c≤0.05,0<α≤2);

LiₐNi_{1-b-c}Mn_{b}X_{c}O_{2-α}T_{α}(0.90≤a≤1.8,0≤b≤0.5,0≤c≤0.05,0<α<2);

LiₐNi_{1-b-c}Mn_{b}X_{c}O_{2-α}T₂(0.90≤a≤1.8,0≤b≤0.5,0≤c≤0.05,0<α<2);

LiₐNi_{b}E_{c}G_{d}O₂(0.90≤a≤1.8,0≤b≤0.9,0≤c≤0.5,0.001≤d≤0.1);

LiₐNi_{b}Co_{c}Mn_{d}GₑO₂(0.90≤a≤1.8,0≤b≤0.9,0≤c≤0.5,0≤d≤0.5,0.001≤e≤0.1);

LiₐNiG_{b}O₂(0.90≤a≤1.8,0.001≤b≤0.1);

LiₐCoG_{b}O₂(0.90≤a≤1.8,0.001≤b≤0.1);

LiₐMn_{1-b}G_{b}O₂(0.90≤a≤1.8,0.001≤b≤0.1);

LiₐMn₂G_{b}O₄(0.90≤a≤1.8,0.001≤b≤0.1);

LiₐMn_{1-g}G_{g}PO₄(0.90≤a≤1.8,0≤g≤0.5);

QO₂;QS₂;LiQS₂;

V₂O₅;LiV₂O₅;

LiZO₂;

LiNiVO₄;

Li_{(3-f)}J₂(PO₄)₃(0≤f≤2);

Li_{(3-f)}Fe₂(PO₄)₃(0≤f≤2); and

LiaFePO₄(0.90≤a≤1.8).

In the above chemical formulas, A is selected from among Ni, Co, Mn, and one or more combinations thereof; X is selected from among Al, Ni, Co, Mn, Cr, Fe, Mg, Sr, V, a rare earth element, and one or more combinations thereof; D is selected from among O, F, S, P, and one or more combinations thereof; E is selected from among Co, Mn, and a combination thereof; T is selected from among F, S, P, and one or more combinations thereof; G is selected from among Al, Cr, Mn, Fe, Mg, La, Ce, Sr, V, and one or more combinations thereof; Q is selected from among Ti, Mo, Mn, and one or more combinations thereof; Z is selected from among Cr, V, Fe, Sc, Y, and one or more combinations thereof; and J is selected from among V, Cr, Mn, Co, Ni, Cu, and one or more combinations thereof.

The compounds may have a coating layer on the surface, or may be mixed with another compound having a coating layer. The coating layer may include at least one coating element compound selected from among an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or one or more combinations thereof. A method of forming the coating layer may be a method that does not adversely affect physical properties of the positive electrode active material, for example, spray coating, dipping, dry coating, atomic deposition, evaporation, and/or the like.

The positive electrode active material may be, for example, at least one of lithium composite oxides represented by Chemical Formula 11.

LiₐM¹¹_{1-y11-z11}M¹²_{y11}M¹³_{z11}O₂ Chemical Formula 11

In Chemical Formula 11, 0.9≤a≤1.8, 0≤y11≤1, 0≤z11≤1, 0≤y11+z11<1, and M¹¹, M¹², and M¹³ may each independently be Ni, Co, Mn, Al, Mg, Ti, Fe, or one or more combinations thereof.

For example, M¹¹ may be Ni and M¹² and M¹³ may each independently be a metal of Co, Mn, Al, Mg, Ti, or Fe. For example, M¹¹ may be Ni, M¹² may be Co, and M¹³ may be Mn or Al, but the present disclosure is not limited thereto.

In an embodiment, the positive electrode active material may be a lithium nickel-based oxide represented by Chemical Formula 12.

Liₐ₁₂Niₓ₁₂M¹⁴_{y12}M¹⁵_{1-x12-y12}O₂ Chemical Formula 12

In Chemical Formula 12, 0.9≤a12≤1.8, 0.3≤x12≤1, 0≤y12≤0.7, M¹⁴ and M¹⁵ may each independently be Al, B, Ce, Co, Cr, F, Mg, Mn, Mo, Nb, P, S, Si, Sr, Ti, V, W, Zr or one or more combinations thereof.

The positive electrode active material may include, for example, a compound of Chemical Formula 13.

Liₐ₁₃Niₓ₁₃Co_{y13}M¹⁶_{1-x13-y13}O₂ Chemical Formula 13

In Chemical Formula 13, 0.9≤a13≤1.8, 0.3≤x13≤1, 0≤y13≤0.7, and M¹⁶ may be Al, B, Ce, Cr, F, Mg, Mn, Mo, Nb, P, S, Si, Sr, Ti, V, W, Zr, or one or more combinations thereof.

The content (e.g., amount) of the positive electrode active material may be about 90 wt % to about 98 wt %, for example about 90 wt % to about 95 wt % based on the total weight of the positive electrode active material layer. Each content (e.g., amount) of the binder and the conductive material may be about 1 wt % to about 5 wt % based on the total weight of the positive electrode active material layer.

The binder improves binding properties of positive electrode active material particles with one another and with a current collector. Examples thereof may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but are not limited thereto.

The conductive material is utilized to impart conductivity to the electrode, and any suitable material may be utilized as long as it does not cause chemical change in the battery to be configured, and the material is an electron conductive material.

Examples of the conductive material may include a carbon-based material such as natural graphite, artificial graphite, carbon black, acetylene black, ketjen black, a carbon fiber, a carbon nanofiber, a carbon nanotube, and/or the like; a metal-based material of a metal powder or a metal fiber, and/or the like including copper, nickel, aluminum silver, and/or the like; a conductive polymer such as a polyphenylene derivative; and/or one or more mixtures thereof.

The current collector may include an aluminum foil, but is not limited thereto.

### Rechargeable Lithium Battery

Another embodiment provides a rechargeable lithium battery including a positive electrode, a negative electrode, a separator disposed therebetween, and an electrolyte.

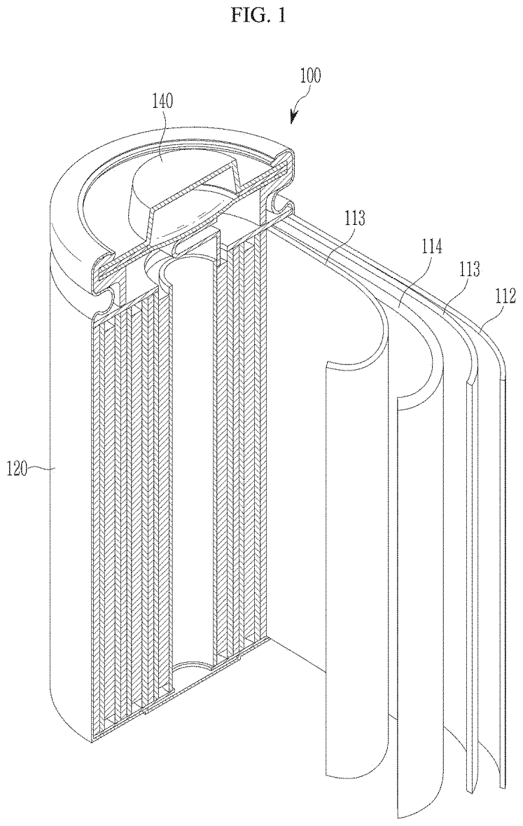

FIG. 1 is a cross-sectional view illustrating a rechargeable lithium battery according to an embodiment. Referring to FIG. 1, a rechargeable lithium battery 100 according to an embodiment includes a battery cell including a positive electrode 114, a negative electrode 112 facing the positive electrode 114, a separator 113 between the positive electrode 114 and the negative electrode 112, and an electrolyte for a rechargeable lithium battery impregnating the positive electrode 114, the negative electrode 112, and the separator 113, a battery case 120 housing the battery cell, and a sealing member 140 sealing the battery case 120.

The electrolyte includes a non-aqueous organic solvent and a lithium salt.

The non-aqueous organic solvent serves as a medium for transmitting ions taking part in the electrochemical reaction of a battery. The non-aqueous organic solvent may be a carbonate-based, ester-based, ether-based, ketone-based, or alcohol-based solvent, or aprotic solvent. Examples of the carbonate-based solvent include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. Examples of the ester-based solvent include methyl acetate, ethyl acetate, n-propyl acetate, dimethyl acetate, methyl propionate, ethyl propionate, γ-butyrolactone, decanolide, valerolactone, mevalonolactone, caprolactone, and/or the like. The ether-based solvent may be dibutyl ether, tetraglyme, diglyme, dimethoxyethane, 2-m ethyltetrahydrofuran, tetrahydrofuran, and/or the like and the ketone-based solvent may be cyclohexanone, and/or the like. In some embodiments, the alcohol-based solvent may be ethyl alcohol, isopropyl alcohol, etc. and the aprotic solvent may be nitriles such as R—CN (in which R is a C2 to C20 linear, branched, or cyclic hydrocarbon group and may include a double bond, an aromatic ring, and/or an ether bond), amides such as dimethylformamide, dioxolanes such as 1,3-dioxolane, sulfolanes, and/or the like.

The non-aqueous organic solvent may be utilized alone or in a mixture. When the organic solvent is utilized in a mixture, the mixture ratio may be controlled or selected in accordance with a desirable (or suitable) battery performance.

In the embodiment of the carbonate-based solvent, a mixture of a cyclic carbonate and a chain carbonate may be utilized. In this embodiment, when the cyclic carbonate and the chain carbonate are mixed in a volume ratio of about 1:1 to about 1:9, the electrolyte may exhibit excellent or suitable performance.

The non-aqueous organic solvent may further include an aromatic hydrocarbon-based organic solvent in addition to the carbonate-based solvent. In this embodiment, the carbonate-based solvent and the aromatic hydrocarbon-based organic solvent may be mixed in a volume ratio of about 1:1 to about 30:1.

As the aromatic hydrocarbon-based solvent, an aromatic hydrocarbon-based compound represented by Chemical Formula I may be utilized.

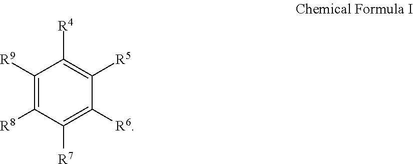

In Chemical Formula I, R⁴ to R⁹ may each independently be the same or different and are selected from among hydrogen, a halogen, a C1 to C10 alkyl group, a haloalkyl group, and one or more combinations thereof.

Examples of the aromatic hydrocarbon-based solvent may be selected from among benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and one or more combinations thereof.

The electrolyte may further include vinylene carbonate or an ethylene carbonate-based compound of Chemical Formula II in order to improve cycle-life of a battery.

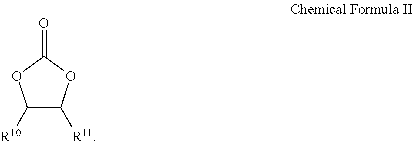

In Chemical Formula II, R¹⁰ and R¹¹ may each independently be the same or different, and are selected from among hydrogen, a halogen, a cyano group, a nitro group, and a fluorinated C1 to C5 alkyl group, provided that at least one of R¹⁰ and R¹¹ is selected from among a halogen, a cyano group, a nitro group, and a fluorinated C1 to C5 alkyl group, but both (e.g., simultaneously) of R¹⁰ and R¹¹ may not be hydrogen.

Examples of the ethylene carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving cycle-life may be utilized within an appropriate or suitable range.

The lithium salt dissolved in the non-aqueous organic solvent supplies lithium ions in a battery, enables a basic operation of a rechargeable lithium battery, and improves transportation of the lithium ions between positive and negative electrodes.

Examples of the lithium salt include at least one supporting salt selected from among LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide): LiFSI), LiC₄F₉SO₃, LiClO₄, LiAlO₂, LiAICl₄, LiPO₂F₂, LiN(CₓF₂ₓ₊₁SO₂)(C_{y}F_{2y+1}SO₂), wherein x and y are natural numbers, for example, an integer in a range of 1 to 20, lithium difluoro(bisoxalato) phosphate, LiCl, Lil, LiB(C₂O₄)₂ (lithium bis(oxalato) borate, LiBOB), and lithium difluoro(oxalato)borate (LiDFOB).

The lithium salt may be utilized in a concentration in a range of about 0.1 M to about 2.0 M. When the lithium salt is included at the above concentration range, an electrolyte may have excellent or suitable performance and lithium ion mobility due to optimal or suitable electrolyte conductivity and viscosity.

The separator 113 separates a positive electrode 114 and a negative electrode 112 and provides a transporting passage for lithium ions and may be any generally utilized/generally available separator in a lithium ion battery. For example, the separator may have low resistance to ion transport and excellent or suitable impregnation for an electrolyte. For example, the separator may be selected from among a glass fiber, polyester, Teflon, polyethylene, polypropylene, polytetrafluoroethylene, and one or more combinations thereof. It may have a form of a non-woven fabric or a woven fabric. For example, in a lithium ion battery, a polyolefin-based polymer separator such as polyethylene and polypropylene is primarily utilized. In order to ensure the heat resistance or mechanical strength, a coated separator including a ceramic component or a polymer material may be utilized. In an embodiment, the separator may have a mono-layered or multi-layered structure.

Rechargeable lithium batteries may be classified as lithium ion batteries, lithium ion polymer batteries, and/or lithium polymer batteries according to the presence of a separator and the type or kind of electrolyte utilized therein. The rechargeable lithium batteries may have a variety of shapes and sizes, and include cylindrical, prismatic, coin, or pouch-type or kind batteries, and may be thin film batteries or may be bulky in size. Structures and manufacturing methods for lithium ion batteries pertaining to this disclosure are generally utilized/generally available in the art.

The rechargeable lithium battery according to an embodiment may be utilized in IT mobile devices and/or the like due to high capacity, excellent or suitable storage stability at high temperature, cycle-life characteristics, and high-rate capability.

Hereinafter, examples of the present disclosure and comparative examples are described in more detail. It is to be understood, however, that the examples are for the purpose of illustration and are not to be construed as limiting the present disclosure.

### Example 1

### Manufacture of Negative Electrode

### First Region

A negative electrode active material was prepared by mixing 93 wt % of a graphite-based first negative electrode active material having a substantially spherical shape, an average particle diameter (D50) of 16.0 μm, a tap density of 1.27 g/cc, and a BET specific surface area of 1.8 m²/g with 7 wt % of a silicon-based active material. The silicon-based active material was a silicon-carbon composite in a form of a core including artificial graphite and silicon particles and soft carbon coated on the surface of the core and had an average particle diameter (D50) of 10.2 μm and a shape substantially similar to a sphere. 96.38 wt % of the prepared negative electrode active material, 2.72 wt % of a styrene-butadiene rubber, and 0.9 wt % of carboxylmethyl cellulose were mixed in distilled water, resulting in a first region composition.

### Second Region

A negative electrode active material was prepared by mixing 93 wt % of a graphite-based second negative electrode active material having an irregular shape, an average particle diameter (D50) of 14.5 μm, a tap density of 1.22 g/cc, and a BET specific surface area of 1.3 m²/g with 7 wt % of a silicon-based active material. The silicon-based active material was substantially the same as utilized in the first region. 98.42 wt % of the prepared negative electrode active material, 0.68 wt % of a styrene-butadiene rubber, and 0.9 wt % of carboxylmethyl cellulose were mixed in distilled water, resulting in a second region composition.

The first region composition and the second region composition were concurrently (e.g., simultaneously) coated on a current collector by utilizing a double slot die applicator so that the first region and the second region were located in order (i.e., first region and second region) on the current collector and then, dried and compressed.

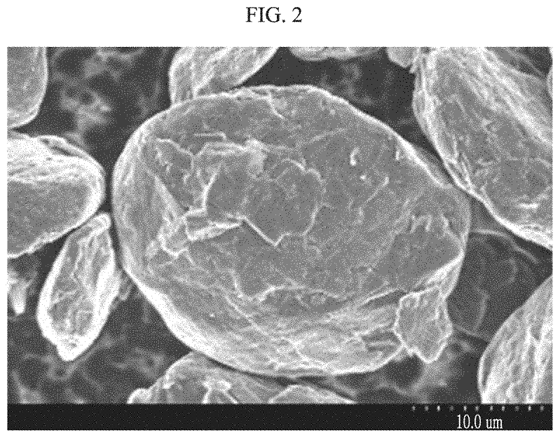

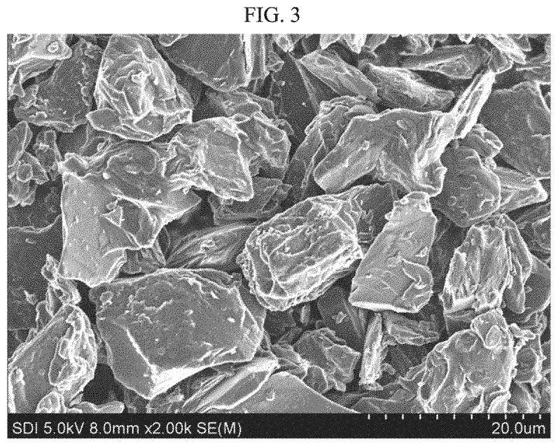

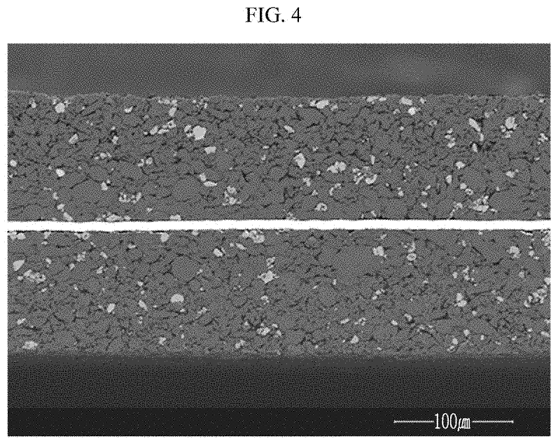

FIG. 2 is a scanning electron microscopic image of the first negative active material, and FIG. 3 is a scanning electron microscopic image of the second negative active material. Comparing FIG. 2 with FIG. 3, the first negative electrode active material and the second negative electrode active material had different morphologies. FIG. 4 is a scanning electron microscope image of the cross-section of the negative electrode plate, which shows that negative electrode active material layers were formed on both (e.g., simultaneously) surfaces (opposite surfaces) of the current collector. The negative electrode active material layer on one surface had a thickness of about 100 μm, wherein the first region had a thickness of about 50 μm, and the second region had a thickness of about 50 μm.

### Manufacture of Battery Cells

A coin half-cell was manufactured by disposing a separator having a polyethylene polypropylene multilayer structure between the prepared negative electrode and a lithium metal counter electrode, and then injecting an electrolyte solution in which 1.0 M LiPF₆ lithium salt was added to a solvent prepared by mixing ethylene carbonate and diethyl carbonate in a volume ratio of 50:50.

### Comparative Example 1

A negative electrode and a cell were manufactured in substantially the same manner as Example 1 except that a second region composition was prepared by mixing 98.42 wt % of the negative electrode active material of the first region, 0.68 wt % of a styrene-butadiene rubber, and 0.9 wt % of carboxylmethyl cellulose. Accordingly, the negative electrodes having the same morphology and properties of the first region and the second region but including the binder in a different ratio were manufactured.

### Comparative Example 2

A negative electrode and a cell were manufactured in substantially the same manner as Example 1 except that the negative electrode active material of the first region was prepared by mixing 86 wt % of the first negative electrode active material and 14 wt % of the silicon-based active material, and the negative electrode active material of the second region utilized 100 wt % of the first negative electrode active material. A negative electrode active material layer according to Comparative Example 2 had a structure in which the silicon-based active material existed in the lower portion (first region) and had substantially the same morphology in the upper and lower portions.

### Evaluation Example 1: Evaluation of Porosity of Negative Electrode

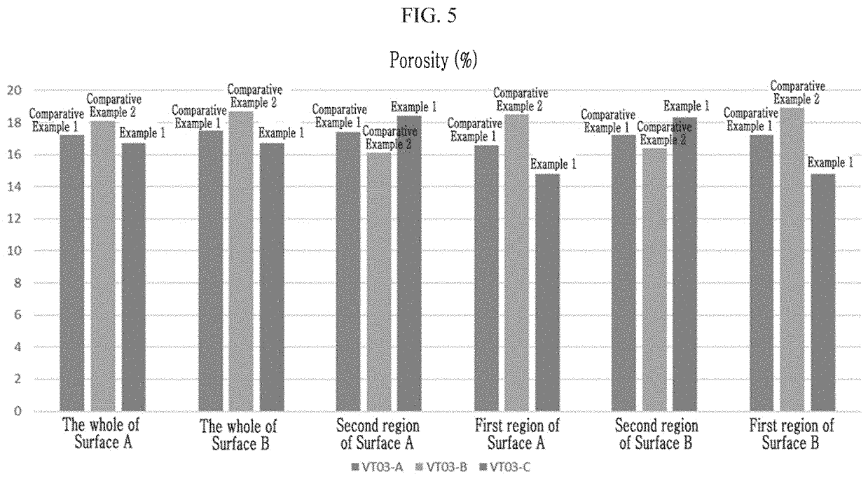

The negative electrodes of Example 1 and Comparative Examples 1 and 2 were measured with respect to porosity of the negative electrode active material layers through nano-computed tomography (nano-CT), and the results are shown in FIG. 5. The measurement was performed by utilizing a device made by Carl Zeiss Xradia 510 Versa under conditions of 80 kV, 7 W, obj: 20×, Binning: 1, Exposure: 20 s. In FIG. 4 showing the cross-section of the negative electrode, an upper surface with a white current collector in the middle was arbitrarily referred to as a surface A, and a lower surface was referred to as a surface B. An analysis range (thickness) thereof was about 75 μm.

As a result of the measurement, on the surface A of Comparative Example 1, the first (inner) region exhibited porosity of 16.6%, the second (outer) region had porosity of 17.4%, and thus a ratio of the porosity of the second region to the porosity of the first region was 104%, and on (under) the surface B of Comparative Example 1, the first region exhibited porosity of 17.2%, the second region exhibited porosity of 17.2%, and thus a ratio of the porosity of the second region to the porosity of the first region was 100%, which confirmed that the porosity of the first region and the porosity of the second region were at the same level.

In some embodiments, referring to FIG. 5, on both of the surface A and the surface B of Comparative Example 2, the second region exhibited higher porosity than the first region. In contrast, on the surface A of Example 1, the porosity of the second region was 18.4%, which was higher than 14.8% of the porosity of the first region, wherein a ratio (e.g., amount) of the porosity of the second region to the porosity of the first region was about 124%. In some embodiments, on the surface B of Example 1, the porosity of the second region was 18.3%, which was higher than 14.8% of the porosity of the first region, wherein a ratio (e.g., amount) of the porosity of the second region to that of the first region was about 124% or so.

### Evaluation Example 2: Evaluation of Battery Cells

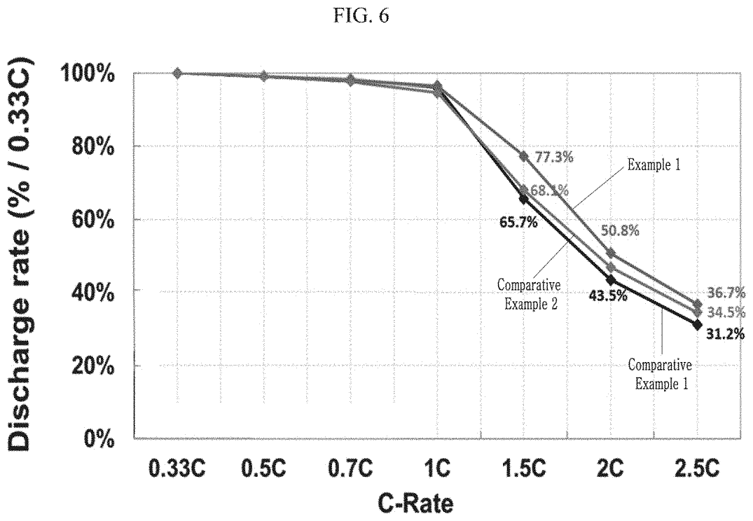

The cells of Example 1 and Comparative Examples 1 and 2 were charged at a constant current of 0.33 C to an upper limit voltage of 4.25 V and cut off in a constant voltage mode at a 0.05 C rate at 25° C. Subsequently, the cells were discharged to 2.8 V at 0.33 C, 0.5 C, 0.7 C, 1.0 C, 1.5 C, 2.0 C, and 2.5 C and evaluated with respect to discharge rates at each rate, and the results are shown in FIG. 6. Referring to FIG. 6, Example 1 exhibited improved (increased) capacity retention at high-rate discharging at 1.5 C, 2.0 C, and 2.5 C.

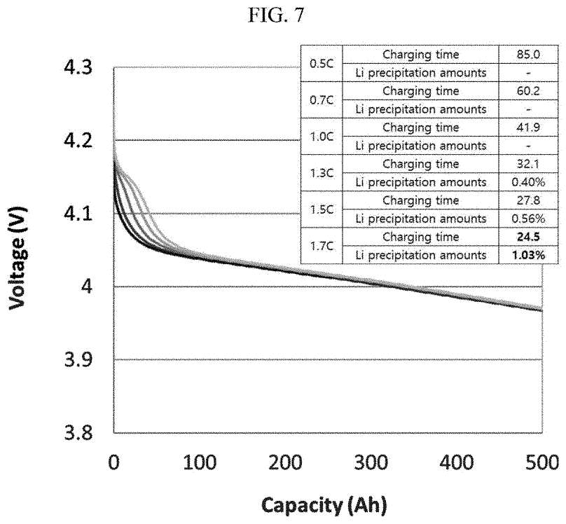

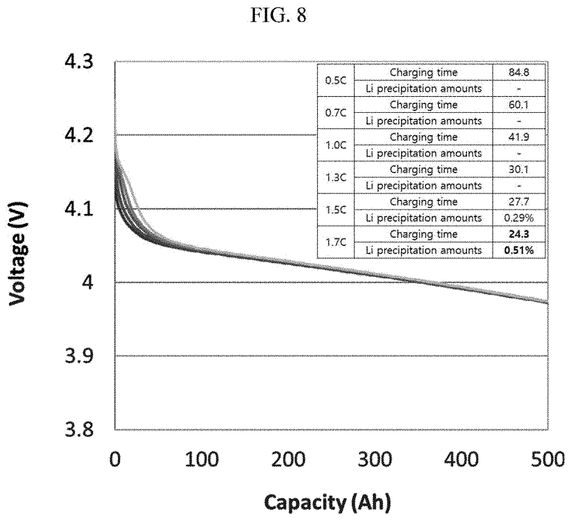

In some embodiments, the cells of Example 1 and Comparative Example 1 were evaluated with respect to lithium precipitation amount during the rapid charging, while the cells were respectively charged at 0.5 C, 0.7 C, 1.0 C, 1.3 C, 1.5 C, and 1.7 C to an upper limit voltage of 4.25 V. The result of Comparative Example 1 is shown in FIG. 7, and the result of Example 1 is shown in FIG. 8. In FIG. 7, Comparative Example 1 exhibited a lithium precipitation amount of 1.03% during the rapid charging at 1.7 C. In contrast, in FIG. 8, Example 1 exhibited a lithium precipitation amount of 0.51%, which was less than 1%, even during the rapid charging at 1.7 C. The lower the lithium precipitation amount was, the better the cycle life characteristics at high rates were, and when the lithium precipitation amount was maintained at less than 1 similar to Example 1, excellent or suitable cycle-life characteristics were obtained with rapid charging and discharging.

### Example 2

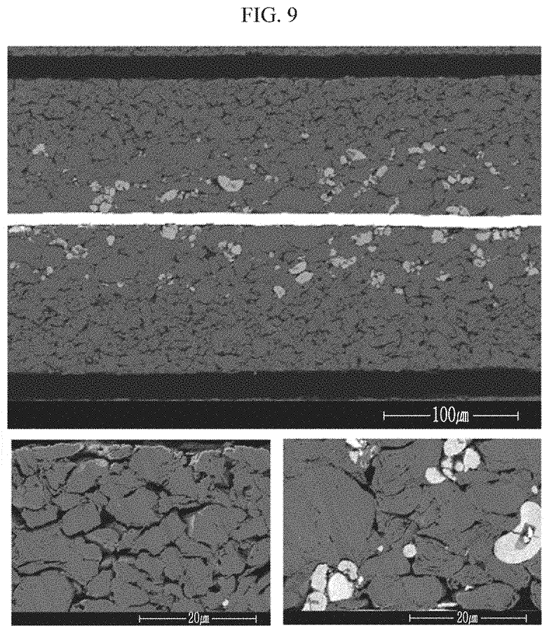

A negative electrode and a cell of Example 1 were manufactured in substantially the same manner as Example 1 except that the negative electrode active material of the first region was prepared by utilizing 86 wt % of the first negative electrode active material and 14 wt % of the silicon-based active material, and 100 wt % of the second negative electrode active material was utilized in the second region. FIG. 9 is a scanning electron microscope showing the cross-section of the negative electrode according to Example 2. Referring to FIG. 9, in the negative electrode of Example 2, the silicon-based active material was present only in the first region, and the first region and the second region exhibited different morphologies.

### Example 3

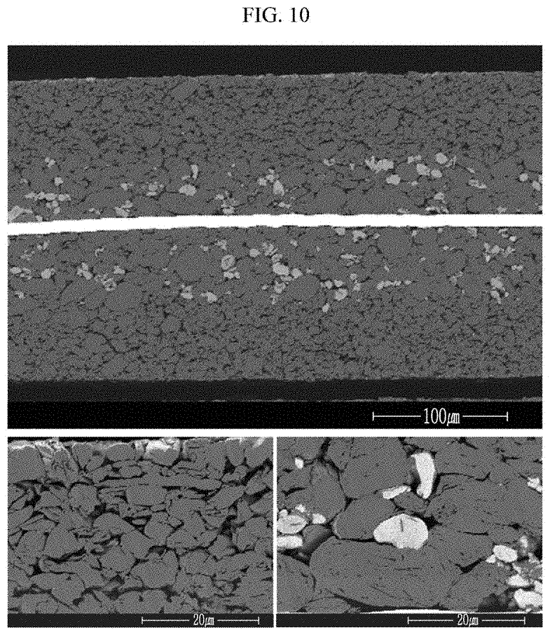

A negative electrode and a cell were manufactured in substantially the same manner as Example 1 except that the negative electrode active material of the first region was prepared by mixing 86 wt % of the first negative electrode active material and 14 wt % of the silicon-based active material, and the negative electrode active material of the second region utilized 100 wt % of a graphite-based second negative electrode active material having an irregular shape, an average particle diameter (D50) of about 11 μm, a tap density of about 1.00 g/cc, and a BET specific surface area of about 1.70 m²/g. FIG. 10 is a scanning electron microscopic image of a cross-section of the negative electrode according to Example 3. Referring to FIG. 10, in the negative electrode of Example 3, the silicon-based active material existed in the first region alone, and the first region and the second region had different morphologies.

### Comparative Example 3

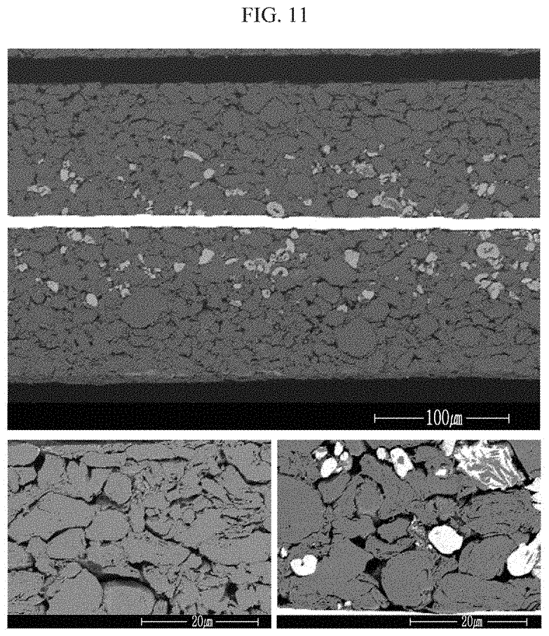

A negative electrode and a cell were manufactured in substantially the same manner as Example 1 except that a negative electrode active material of a first region was prepared by mixing 43 wt % of the first negative electrode active material of Example 1, 43 wt % of the second negative electrode active material of Example 1, and 14 wt % of the silicon-based active material of Example 1, and a negative electrode active material of a second region was prepared by mixing 50 wt % of the first negative electrode active material of Example 1 and 50 wt % of the second negative electrode active material of Example 1. FIG. 11 is a scanning electron microscopic image of a cross section of the negative electrode according to Comparative Example 3. Referring to FIG. 11, in a negative electrode active material layer of Comparative Example 3, a silicon-based active material existed in the lower portion alone, and the upper and lower portions had substantially the same morphologies (even though the silicon-based active material existed in the lower portion alone).

### Evaluation Example 3: Evaluation of Porosity of Negative Electrode

The negative electrodes of Examples 2 and 3 and Comparative Example 3 were measured with respect to porosity of the negative electrode active material layers through a scanning electron microscope (SEM), and the results are shown in Table 1. The measurement was performed by utilizing a scanning electron microscope made by Magellan (FEI Company) and analyzed under conditions of 3 keV, 0.8 nA BSE, and 5 keV, 3.2 nA EDS. In FIG. 9 and/or the like showing the cross-sections of the negative electrodes, the upper surface with a white current collector in the middle is referred to as a surface A, and the lower surface is referred to as a surface B.

TABLE 1

| | | | Porosity (%) |
|---|---|---|---|
| Example 2 | Surface A | first region | 11.25 |
| | | second region | 15.14 |
| | Surface B | first region | 11.37 |
| | | second region | 16.08 |
| Example 3 | Surface A | first region | 11.83 |
| | | second region | 16.95 |
| | Surface B | first region | 10.86 |
| | | second region | 18.74 |
| Comparative | Surface A | first region | 14.02 |
| Example 3 | | second region | 15.49 |
| | Surface B | first region | 14.34 |
| | | second region | 15.42 |

Referring to Table 1, Comparative Example 3 exhibited almost and/or substantially no porosity difference in the first region (lower) and the second region (upper). In contrast, Examples 2 and 3 each exhibited relatively and/or substantially higher porosity in the second region than in the first region and a ratio of the porosity of the second region to the porosity of the first region of 135%, 142%, 143%, 173%, and/or the like.

The use of “may” when describing embodiments of the present disclosure refers to “one or more embodiments of the present disclosure.”

As used herein, the term “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this disclosure is intended to include all higher numerical limitations subsumed therein. Accordingly, Applicant reserves the right to amend this disclosure, including the claims, to expressly recite any sub-range subsumed within the ranges expressly recited herein.

The portable information device, the electric vehicle, the rechargeable lithium battery including its battery management system (BMS) or device, or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components may be implemented on a flexible printed circuit film, a tape carrier package (TCP), a printed circuit board (PCB), or formed on one substrate. Further, the various components may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

Although the embodiments of the present disclosure have been described, it is understood that the present disclosure should not be limited to these embodiments, but one or more suitable changes and modifications can be made by one ordinary skilled in the art within the spirit and scope of the present disclosure as defined by the following claims and equivalents thereof.

### REFERENCE NUMERALS

100: rechargeable lithium battery
112: negative electrode
113: separator
114: positive electrode
120: battery case
140: sealing member

What is claimed is:

1. A negative electrode for a rechargeable lithium battery comprising:
a current collector; and
a negative electrode active material layer on the current collector,
wherein the negative electrode active material layer comprises:
a first region in contact with the current collector and comprising a first negative electrode active material; and
a second region on the first region and comprising a second negative electrode active material,
wherein each of the first negative electrode active material and second negative electrode active material has an average particle diameter (D50) of about 9 μm to about 22 μm,
morphologies of the first negative electrode active material and the second negative electrode active material are different from each other,
a porosity of the second region is higher than a porosity of the first region, and
a ratio of the porosity of the second region to the porosity of the first region is from about 110% to about 190%.

2. The negative electrode of claim 1, wherein the first negative electrode active material has a particle form that is substantially spherical and the second negative electrode active material has a particle form that is substantially amorphous.

3. The negative electrode of claim 1, wherein each of the first negative electrode active material and the second negative electrode active material is a carbon-based active materials.

4. The negative electrode of claim 1, wherein a tap density of the first negative electrode active material is from about 1.2 g/cc to about 1.5 g/cc, and a tap density of the second negative electrode active material is from about 0.8 g/cc to about 1.4 g/cc.

5. The negative electrode of claim 1, wherein a BET (Brunauer, Emmett and Teller) specific surface area of the first negative electrode active material is from about 1.4 m²/g to about 2.0 m²/g, and the specific surface area of the second negative electrode active material is from about 1.0 m²/g to about 1.8 m²/g.

6. The negative electrode of claim 1, wherein at least one of the first region or the second region further comprises a silicon-based active material.

7. The negative electrode of claim 6, wherein the silicon-based active material is included in an amount of about 1 wt % to about 15 wt % based on the total weight of the at least one of the first region or the second region.

8. The negative electrode of claim 6, wherein an average particle diameter (D50) of the silicon-based active material is from about 5 μm to about 15 μm.

9. The negative electrode of claim 1, wherein each of the first region and the second region has from about 30 μm to about 100 μm in thickness.

10. The negative electrode of claim 1, wherein
the first region and the second region further include a binder, and
a weight ratio of the binder in the first region to the binder in the second region is from about 60:40 to about 95:5.

11. A rechargeable lithium battery, comprising
the negative electrode for a rechargeable lithium battery according to claim 1, a positive electrode, and an electrolyte.

12. A portable information device comprising the rechargeable lithium battery of claim 11.

13. An electric vehicle comprising the rechargeable lithium battery of claim 11.
